(19) United States
(12) Patent Application Publication
(10) Pub. No.: US 2012/0014645 A1
(43) Pub. Date: Jan. 19, 2012

(54) SINGLE LENS, MULTI-FIBER OPTICAL CONNECTION METHOD AND APPARATUS

(75) Inventor: Michael Aaron Kadar-Kallen, Harrisburg, PA (US)

(73) Assignee: Tyco Electronics Corporation, Berwyn, PA (US)

(21) Appl. No.: 12/836,067

(22) Filed: Jul. 14, 2010

(51) Int. Cl. G02B 6/32

(52) U.S. Cl. 385/33; 385/74

(57) ABSTRACT

The invention pertains to an expanded beam optical coupling method and apparatus comprising a single lens per connector through which the light from multiple fibers is expanded/focused to couple to corresponding fibers in a mating connector.

### FIELD OF TECHNOLOGY

The invention pertains to optoelectronics. More particularly, the invention pertains to a method and apparatus for coupling light between two fibers at an optical connector.

### BACKGROUND

It is typically the case that an optical signal transported over an optical fiber must be coupled between that optical fiber and another optical fiber or an optoelectronic device. Typically, the end of the optical fiber is outfitted with an optical connector of a given form factor, which connector can be coupled to a mating optical connector on the other fiber (or optoelectronic device).

Optical cables that are connected to each other through a pair of mating connectors may comprise a single optical fiber. However, more and more commonly, optical cables contain a plurality of optical fibers and the light in each optical fiber in the cable is coupled through a pair of mating connectors to a corresponding optical fiber in another cable.

Optical connectors generally must be fabricated extremely precisely to ensure that as much light as possible is transmitted through the mating connectors so as to minimize signal loss during transmission. In a typical optical fiber, the light is generally contained only within the core of the fiber, which typically may be about 10 microns in diameter for a single-mode fiber or about 50 microns in diameter for a multi-mode fiber. Accordingly, lateral alignment of the fibers in one connector with the fibers in the other connector must be very precise. Also, a speck of dust typically is greater than 10 microns in cross section. Accordingly, a single speck of dust at the interface of two connectors can substantially or even fully block the optical signal in a fiber from getting through the connectors.

Accordingly, it is well known to use expanded beam connectors in situations where it is likely that connections will be made in the field, and particularly in rugged or dusty environments. Expanded beam connectors include optics (e.g., lenses) that expand the beam so as to increase the beam's cross section at the optical interface of the connector (i.e., the end of the connector that is designed to be connected to another optical connector or optoelectronic device). Depending, of course, on the direction of light travel through the connector, the lens either expands a beam exiting a fiber to a greater cross section for coupling to the corresponding lens of a mating connector or focuses a beam entering the lens from a corresponding lens of another connector to a focal point in the face of a fiber.

### SUMMARY

The invention pertains to an expanded beam optical coupling method and apparatus comprising a single lens per connector through which the light from multiple fibers is expanded/focused for coupling to corresponding fibers in a mating connector. The lens in one connector expands and collimates the beams from the optical fibers of its cable. The lens in the other, mating connector focuses the expanded beams and images them to a corresponding fiber in its cable. This form of single lens coupling is highly tolerant of significant lateral misalignment between the lenses. It also is highly tolerant of dust.

### BRIEF DESCRIPTION OF THE DRAWINGS

FIG. 1 is a schematic diagram of two mating optical connectors in accordance with the principles of a first embodiment of the invention illustrating the coupling of light between one pair of corresponding fibers in the two connectors.

FIG. 2 is a diagram illustrating light paths in accordance with the principles of the first embodiment of the invention for six idealized exemplary fiber-to-fiber optical couplings.

FIG. 3 is a diagram illustrating light paths in accordance with the principles of the first embodiment of the invention for six exemplary fiber-to-fiber optical couplings in which the fibers in the first connector are laterally misaligned from the fibers in the second connector.

FIG. 4 is a front plan view of the optical fibers in a fiber optic cable according to one embodiment of the invention.

### DETAILED DESCRIPTION OF EMBODIMENTS

Conventionally, an optical connector employing an expanded beam coupling includes a separate lens for each fiber. Specifically, each optical fiber of a fiber optic cable typically is separated from the other fibers and inserted into a separate ferrule in a ferrule assembly of the connector, each ferrule precisely aligning its fiber laterally (i.e., transverse the optical axis of the fiber) in the connector for optical coupling to the corresponding fiber in a mating connector. A lens is disposed at the front end of each ferrule for expanding and collimating the beam exiting the fiber (or focusing a beam on the front face of the fiber, in the case of light traveling in the other direction into the fiber from the corresponding fiber of a mating connector).

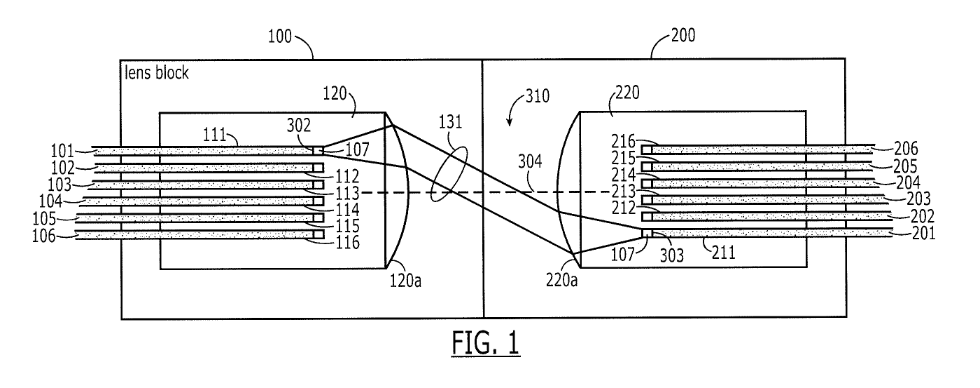

FIG. 1 illustrates the principles of the present invention, in which a single lens per connector expands, collimates, and images the light beams from multiple fibers in that connector to corresponding fibers in a mating connector. As will be described in greater detail herein below, this design is tolerant of substantial lateral misalignment between the two mating connectors while still coupling light between the two mating fibers.

FIG. 1 illustrates two mating connectors 100 and 200, each containing six fibers 101, 102, 103, 104, 105, 106 (in connector 100) and 201, 202, 203, 204, 205, 206 (in connector 200) aligned in a plane. However, this is merely exemplary. The invention may be used in connection with cables and connectors containing any number of optical fibers and in any spatial layout. Each connector includes a single lens 120, 220, respectively. The first and second lenses 120, 220 are positioned with their front faces 120a, 220a substantially facing each other and with their optical axes substantially parallel to each other. The second lens 220 is positioned to receive light beams from the first plurality of optical fibers 101-106 exiting the front face 120a of the first lens 120 and vice versa.

FIG. 1 illustrates a single curved surface, e.g., a “singlet” lens. This is merely exemplary, as the lenses used in expanded beam connectors may be of several types. For instance, the “lens” may contain multiple lens elements that are either cemented together or are held in a precise relationship with respect to each other. The fiber array may be molded as one piece, and the lens may be separate. The separate parts may be passively assembled, using alignment features such as pins/holes. Alternatively, the parts may be aligned using some type of feedback mechanism. Furthermore, the lens elements in such an assembly may be made of different materials. Alternately, the lens may be a gradient index lens having a graded index of refraction, where the index of refraction varies either along the axis of symmetry of the lens (a function of z) or as a function of the radial distance from this axis of symmetry (a function of r). Other types of suitable lenses that may be used in this application include holographic or diffractive optical elements, which also are considered “lenses”. The term, lens as used herein is used in its broadest sense to include any optics that can be used to collimate light.

In this exemplary embodiment, the two connectors 100, 200 are optically identical to each other. Therefore, let us discuss the left-hand connector 100 with the knowledge that the other connector 200 is identical.

The lens 120 may be a molded polymer lens. It includes six bores 111, 112, 113, 114, 115, 116 into which one of the fibers 101-106 is inserted. In one embodiment, the diameters of the bores 111-116 are substantially equal to or very slightly larger than the diameters of the fibers 101-106 so that the fibers fit tightly within the bores. In one embodiment, an epoxy 107 having an index of refraction substantially equal to the index of refraction of the lens 120 is injected into the bores 111-116 before the fibers 101-106 are inserted and then the epoxy cured to fix the fibers in the bores. Note that the drawings are not necessarily to scale. For instance, the amount of space provided for the epoxy 107 is exaggerated.

Using an epoxy with an index of refraction substantially equal to the index of refraction of the lens will reduce or eliminate the need to polish the ends of the fibers. Specifically, in conventional optical connectors in which the ends of the fibers are in air or butted against another optical element, the ends of the fibers typically need to be polished extremely smooth to maximize optical throughput. However, with the end faces of the fibers embedded in an epoxy that molds itself to the profile of the end face of the fibers as well as the mating surface of the lens and has the same (or a reasonably close) index of refraction to that of the fiber and/or the lens, optical losses through the interface should be minimal without the need for polishing the ends of the fibers.

The lens 120 is designed to expand the beam from each fiber 101-106 and collimate the light upon exiting the lens from the front face 120a into the air gap 310 between the two lenses 120, 220. For sake of clarity and simplicity, the beam 131 of only one fiber 101 is shown in FIG. 1. The lens also is designed to direct the collimated beam 131 to an image point 303 diametrically opposite the originating field point 302 about the optical axis 304 of the lens 120, where the front face of the corresponding fiber 201 in the mating connector 200 is located.

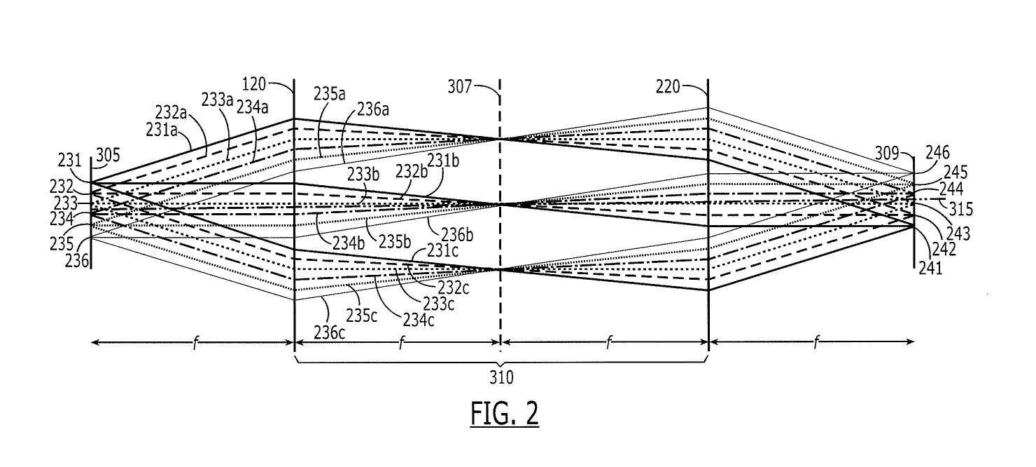

FIG. 2 is a beam diagram corresponding to the embodiment of FIG. 1 showing exemplary paths of the idealized point sources 231, 232, 233, 234, 235, 236 from all six fibers. The lenses 120, 220 are modeled as idealized, infinitely thin lenses. Three lines are shown for the beam from each point source (e.g., fiber), namely, (1) a first line 231b, 232b, 233b, 234b, 235b, and 236b demonstrative of the path of light at the center of the beam, (2) a second line 231a, 232a, 233a, 234a, 235a, and 236a demonstrative of the path of light at the top-most extent of the beam, and (3) a third line 231c, 232c, 233c, 234c, 235c, and 236c demonstrative of the path of light at the bottom-most extent of the beam. Line 305 defines the field plane of the six point sources, i.e., the plane defined by the ends of the fibers/beginning of the lens in connector 100. Line 309 defines the image plane of the six beams, i.e., the plane defined by the ends of the fibers/beginning of the lens in connector 200. Line 309 defines the plane of the image points (i.e., the front faces of the receiving fibers on which the beams are focused). Finally, line 307 is the midplane of the two connectors. Line 307 does not necessarily correspond to any physical component or interface, but is the centerline or half-way point between the field plane 305 and the image plane 309.

As can be seen in FIG. 2, each beam expands in air for a distance of one focal length, f, to the first lens 120. Then, lens 120 collimates the light so that a collimated beam exits the first lens 120 into air. Then, each beam travels two focal lengths, 2f, through the air gap 310 between the two lenses 120, 220. Finally, each beam enters the second lens 220, which focuses the beam. Over the distance of one more focal length, f, each beam is focused onto the image point 241, 242, 243, 244, 245, 246 in the image plane 309, i.e., the front face of the corresponding fiber in the second connector. The optical system has a magnification of −1. As a result, the image of the array of source fibers is the same size as the array of receiving fibers. The relative orientation of the receiving fibers with respect to the image of the source fibers is determined by the mechanical connector structure, including any keying features that may be used to control the rotation of one connector with respect to the other.

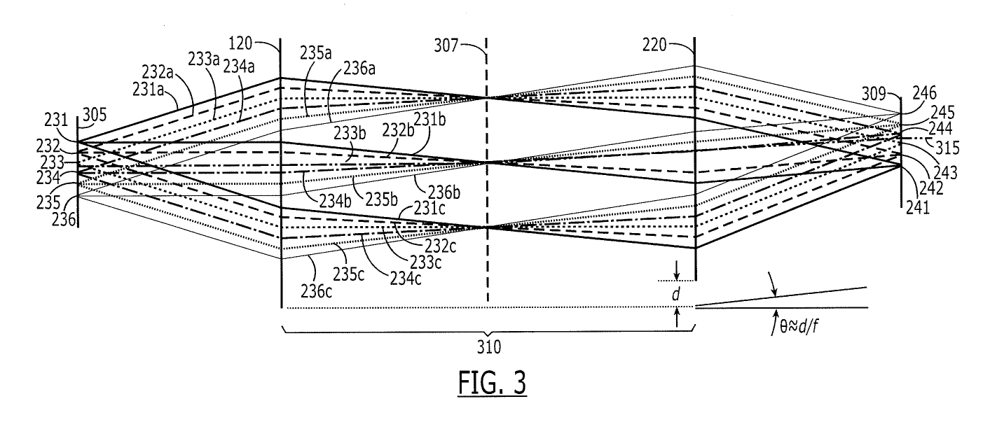

In the example of FIG. 2, the two lenses are perfectly aligned with their optical axes on axis 315. However, the optics of two opposing collimating lenses 120, 220 are such that, even if the optical axes of the two lenses are significantly offset from each other, the image points 241-246 will remain unchanged relative to the front of the receiving lens 200 in the direction transverse the optical axis of the lens 200. FIG. 3 helps illustrate this fact. Particularly, FIG. 3 is similar to FIG. 2 except the two lenses are offset laterally from each other by a distance, d.

As long as the light is collimated and enters the front of the lens 220, the image points will remain in the same locations relative to the receiving lens 200. The image points 241-246 will remain in the same locations because the light entering the front of the lens 220 is collimated. More particularly, they will remain in the same image plane 309 because the focal length of the lens dictates the distance of the image points from the lens; and in the same lateral locations relative to the lens 200 because the angles of the collimated beams of light in the region 310 determine the lateral locations at the image plane 309.

Thus, by using a single lens to expand and collimate the light from all of the fibers in the connector, the connector system is substantially insensitive to lateral misalignment of the fibers. Hence, the connectors and ferrule alignment systems need not be manufactured to as precise tolerances as might otherwise be required of more conventional connector designs. As long as each lens is precisely laterally aligned with the fibers in its own connector (i.e., the lateral position of lens 120 relative to fibers 101-106 in connector 100 is the same as the lateral position of lens 220 relative to the fibers 201-206 in connector 200), the two connectors 100, 200 themselves can be substantially misaligned laterally with no ill effect.

For exemplary purposes, let us assume that the fiber pitch in the connectors 100, 200 is 0.25 mm and the lateral offset, d, in FIG. 3 is 0.5 mm, i.e., twice the fiber pitch in the connectors. Let us also assume that the focal length is 5 mm and the numerical aperture (NA) of the fibers is 0.3. The NA defines the maximum angle from the optical axis of the fiber at which light can enter and travel down the fiber. More particularly, the NA=n sin(θ), where n is the index of refraction of the material in which the NA is measured. For multimode fibers, θ is the maximum angle accepted by the fiber. For single mode fibers, θ is typically defined as the angle at which the intensity of the light is 1/(e²) times the intensity of the light on axis.

When the two lenses 120, 220 are laterally aligned as shown in FIG. 2, then the central portions 231b, 232b, 233b, 234b, 235b, 236b of the beams will impinge on the fiber front faces parallel to the optical axis of the fibers (i.e., 0 degrees). If the two lenses are laterally offset from each other, then the angular offset, θ, measured in radians will be approximately equal to d/f, where d is the lateral offset and f is the focal length of the lenses, as previously noted. Thus, as long as the angular offset is kept well within the NA of the fibers, the vast majority of the light will still enter the fibers.

Connectors in accordance with the principles of the invention will be substantially less sensitive to lateral misalignment.

The lenses 120, 220 are coated with an anti-reflection coating to minimize what would otherwise be approximately 0.3 dB of Fresnel loss at the two lens/air interfaces.

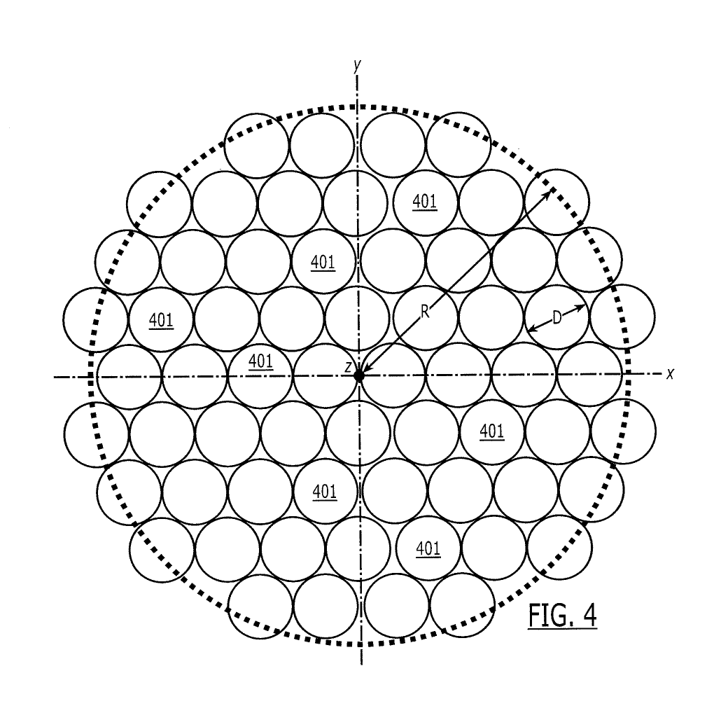

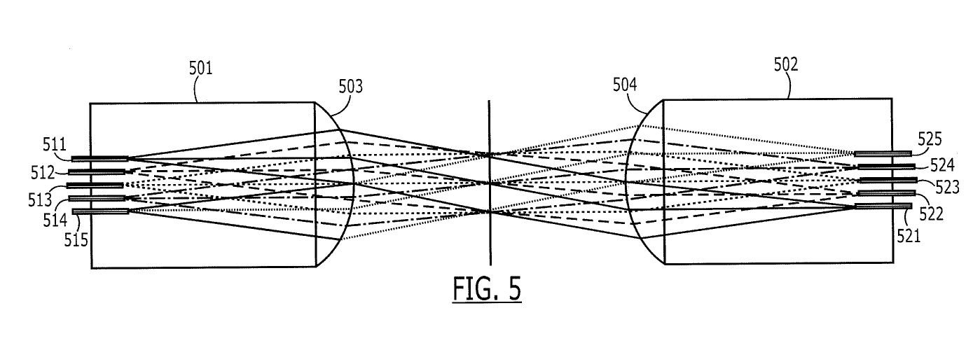

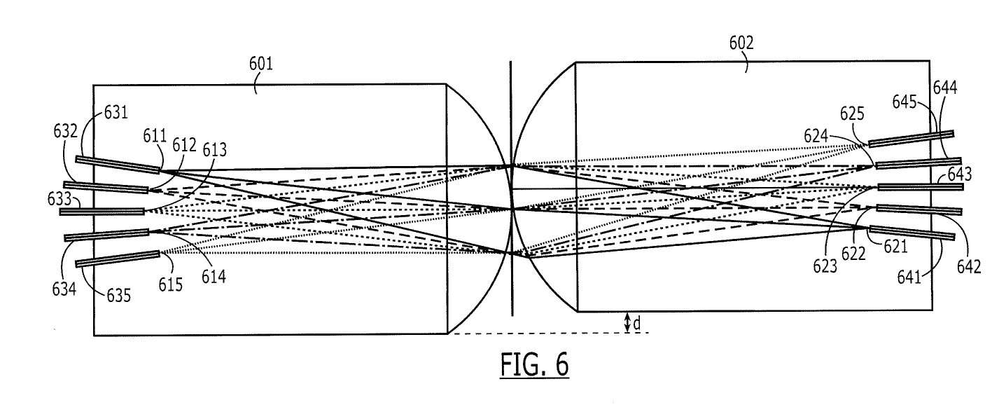

It is not uncommon for a fiber optic cable to contain a very large number of optical fibers, such as 64 or more. Furthermore, the light transmitting cores of the fibers typically will be surrounded by their cladding and coating right up to the end faces. Hence, the single lens in the connector may need to be relatively large. Larger lenses are more difficult to manufacture. Accordingly, it is preferable to arrange the end faces of the optical fibers so that the fibers are packed as closely together as possible for interfacing to the lens. FIG. 4 is a front plan view of a regular hexagonally packed set of 64 cylindrical fibers as viewed at the front faces of the fibers. In a regular hexagonal packing arrangement, the outer circumference of each fiber 401 (except the diametrically outermost layer of fibers and a few of the next outermost layer of fibers) is in point contact with each of six of the surrounding fibers. This allows 64 fibers to be packaged within a radius, R, that is about 4.09 times the fiber diameter, D. Also, note that the geometric center 402 of the 64 fibers is between fibers. Other arrangements are possible, including arrangements in which the geometric center of the collection of fiber end faces is at the center of a central fiber. Whatever packing arrangement is selected, it preferably is symmetrical about the x and y axes because the field points are to be imaged about the optical axis (i.e., z axis). Regular hexagonal packing is one arrangement, but it is merely exemplary. Generally, it will be desirable, although not a requirement, to pack the fibers in an arrangement that minimizes the maximum radial distance R from the optical axis of the lens to the outermost fiber. The most efficient packing arrangement may vary depending on the number of fibers to be packed. Furthermore, there may be several options for any given number of fibers.

While the exemplary embodiments discussed above each show the field points of all of the transmitting fibers in the same plane and the image points of all of the receiving fibers in the same plane, this is merely exemplary. It is not necessary that all of the fibers in each connector terminate in the same plane. In fact, if the field points and/or image points are not coplanar, it provides the optical designer an extra degree of freedom when designing the imaging system. FIG. 5, for instance, shows a pair of mating optical connectors 501, 502 in which the field points 511, 512, 513, 514, 515 are not coplanar and the image points 521, 522, 523, 524, 525 are not coplanar.

Furthermore, it is not necessary that all of the beams enter the lens parallel to each other. Theoretically, each beam could enter the lens at a different angle. That is, the optical axes of the fibers at their end faces need not be parallel to each other. (Note also that the end faces of the fibers may be of any angle to the optical axes of the fibers or of any shape, e.g., curved.)

FIG. 6, for instance, shows a pair of mating optical connectors 601, 602 that are laterally offset from each other by a distance d in which beams (each represented by three rays in the diagram) originating at field points 611, 612, 613, 614, 615 at the ends of fibers 631, 632, 633, 634, and 635 enter the lens at different angles. Furthermore, the field points are not coplanar. The beams are directed to the image points 621, 622, 623, 624, 625, which also are not coplanar. Furthermore, the fibers 641, 642, 643, 644, 645 are not parallel. Note further that this system is not a 4F system, as were the previously described embodiments. In fact, the lenses are actually touching in this embodiment.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. An optical connector system for coupling a beam from each optical fiber of a first plurality of optical fibers to a corresponding optical fiber of a second plurality of optical fibers comprising:
a first single lens positioned in front of the first plurality of fibers, the first lens adapted to expand beams from the first plurality of fibers as they travel through the lens and collimate the beams from the first plurality of fibers upon exiting a front face of the first lens;
a second single lens positioned in front the second plurality of fibers, the second lens adapted to expand beams from the second plurality of fibers as they travel through the lens and collimate the beams from the second plurality of fibers upon exiting a front face of the second lens; and
the first and second lenses positioned with their front faces substantially facing each other and with their optical axes substantially parallel to each other, wherein the second lens is positioned to receive light beams from the first plurality of optical fibers exiting the first lens.

2. The connector system of claim 1 wherein the first and second lenses are substantially identical.

3. The connector system of claim 1 further comprising a gap between the first and second lenses.

4. The connector system of claim 1 wherein the fibers of the first plurality of fibers are disposed within bores in the first lens and the fibers of the second plurality of fibers are disposed within bores in the second lens.

5. The connector system of claim 4 further comprising an epoxy fixing the optical fibers in their respective bores.

6. The connector system of claim 5 wherein the first lens has a first index of refraction, the second lens has a second index of refraction, and the epoxy has a third index of refraction, and wherein the first, second, and third indices of refraction are substantially the same.

7. The connector system of claim 1 wherein the first plurality of fibers are disposed relative to each other in a regular hexagonal packing arrangement and the second plurality of fibers are disposed relative to each other in a regular hexagonal packing arrangement.

8. The connector system of claim 1 wherein the first and second lenses are further adapted to image the beams substantially diametrically opposite about their respective optical axes.

9. The connector system of claim 1 wherein the fibers of the first plurality of fibers have end faces and the fibers of the second plurality of fibers have end faces and wherein the end faces of the first plurality of fibers are not coplanar and the end faces of the second plurality of fibers are not coplanar.

10. The connector system of claim 1 wherein the fibers of the first plurality of fibers have end faces and the fibers of the second plurality of fibers have end faces and wherein the fibers of the first plurality of fibers are oriented so that the optical axes of the fibers of the first plurality of fibers at the end faces of the fibers are not parallel to each other and wherein the fibers of the second plurality of fibers are oriented so that the optical axes of the fibers of the second plurality of fibers at the end faces of the fibers are not parallel to each other.

11. The connector system of claim 1 wherein the first lens is disposed within a first hermaphroditic connector housing and the second lens is disposed within a second hermaphroditic connector housing, the first and second hermaphroditic connector housings adapted to mate hermaphroditically.

12. An optical connector for coupling a beam from each optical fiber of a first plurality of optical fibers to a corresponding optical fiber of a second plurality of optical fibers comprising:
a single lens positioned in front of the first plurality of fibers, the first lens adapted to expand beams from each of the first plurality of fibers as they travel through the lens and collimate the beams from the first plurality of fibers upon exiting the lens; and
a connector housing.

13. The optical connector of claim 12 wherein the fibers of the first plurality of fibers are disposed within bores in the first lens.

14. The optical connector of claim 13 further comprising an epoxy fixing the optical fibers in their respective bores.

15. The optical connector of claim 14 wherein the lens has a first index of refraction and the epoxy has a second index of refraction, and wherein the first and second indices of refraction are substantially the same.

16. The optical connector of claim 12 wherein the first plurality of fibers are disposed relative to each other in a regular hexagonal packing arrangement.

17. The optical connector of claim 12 wherein the lens is further adapted to image the beams substantially diametrically opposite about the optical axis of the lens.

18. The optical connector of claim 12 wherein the fibers of the first plurality of fibers have end faces adjacent the first lens and wherein the end faces of the first plurality of fibers are not coplanar.

19. The connector system of claim 12 wherein the fibers of the first plurality of fibers have end faces and the fibers of the second plurality of fibers have end faces and wherein the fibers of the first plurality of fibers are oriented so that the optical axes of the fibers of the first plurality of fibers at the end faces of the fibers are not parallel to each other and wherein the fibers of the second plurality of fibers are oriented so that the optical axes of the fibers of the second plurality of fibers at the end faces of the fibers are not parallel to each other.

20. A method of optically coupling light from a plurality of beams, each beam having a distinct field point, to a plurality of distinct image points comprising:
passing the plurality of beams through a single first lens to expand each of the beams in the plurality of beams and collimate the beams upon exiting the first single lens;
passing the collimated plurality of beams exiting the first lens through a second single lens positioned in front of the image points, the second lens adapted to focus the collimated beams exiting the first lens onto the image points; and
the first and second lenses positioned with their optical axes substantially parallel to each other.

21. The method of claim 20 wherein the first and second lenses are substantially identical.

22. The method of claim 21 further comprising:
placing the fibers of the first plurality of fibers within bores in the lens.

23. The method of claim 22 further comprising:
affixing the fibers of the first plurality of fibers in the bores with an epoxy.

24. The method of claim 23 wherein the lenses have a first index of refraction and the epoxy has a second index of refraction, and wherein the first and second indices of refraction are substantially the same.

25. The method of claim 20 further comprising:
packing the first plurality of fibers relative to each other in a regular hexagonal packing arrangement.

26. The method of claim 20 further comprising:
using the lens to image the plurality of beams substantially diametrically opposite about the optical axis of the lens.
